(19) United States
(12) Patent Application Publication
(10) Pub. No.: US 2008/0100060 A1
(43) Pub. Date: May 1, 2008

(54) Pipe joint

(75) Inventors: Kaneyoshi Hayashi, Saitama (JP); Shigeyoshi Hayashi, Saitama (JP)

Correspondence Address: DILWORTH & BARRESE, LLP, 333 EARLE OVINGTON BLVD., SUITE 702, UNIONDALE, NY, 11553, US

(73) Assignee: Sankei Giken Co., Ltd., Osaka (JP)

(21) Appl. No.: 11/978,365

(22) Filed: Oct. 29, 2007

(30) Foreign Application Priority Data
Oct. 31, 2006 (JP) 2006-296384

(51) Int. Cl. F16L 23/08

(52) U.S. Cl. 285/148.8

(57) ABSTRACT

A pipe joint is provided that effectively accommodates a relative positional displacement between pipes, thereby allowing unfailing coupling between the pipes.

The pipe joint is provided with a flexible pipe main body in a circular cylindrical shape; a pair of flanges that is provided on both ends the pipe main body, and are coupled to end portions of the first pipe and the second pipe that face each other; and a plurality of string members that couple the flanges. Each string member includes a string main body and a pair of stopping members that are provided on both ends of the string main body with a predetermined distance, and the flanges are formed in an annular shape and include a plurality of flange pieces that are separately formed, an ear portion having a coupling hole for coupling the flange pieces, a coupling bolt that couples the flange pieces, and the application bolt that couples the first pipe and the second pipe. The coupling bolt and/or the application bolt is provided with a through hole through which the string main body is inserted in the length direction, and a housing portion communicating with the through hole and having an opening area wider than that of the through hole.

This application is based on and claims the benefit of priority from Japanese Patent Application No. 2006-296384, filed on 31 Oct. 2006, the content of which is incorporated herein by reference.

### BACKGROUND OF THE INVENTION

1. Field of the Invention

The present invention relates to pipe joints, and in particular to a flexible pipe joint.

2. Related Art

Conventionally, water distributing pipes, gas pipes and the like that are installed in various buildings and facilities, for example, are known as pipes for fluid transportation. These pipes are coupled via pipe joints so that a relative positional displacement between the coupling portions of the pipes can be reduced. Such a pipe joint is provided with, for example, a flexible pipe main body and flanges that are disposed at respective ends of this pipe main body. The pipe main body is, in general, made of an elastic and flexible material such as rubber, and grooves or ridges, for example, are provided for increased flexibility along an outer periphery in an axial cross-section of the pipe main body. With this configuration, even when a relative positional displacement between coupling portions of the pipes occurs, it is possible to accommodate the displacement.

However, the above conventional pipe joint has the pipe main body formed by a flexible material such as rubber, and therefore, when a drastic tensile load or shear stress is applied to the pipe joint due to, for example, a large earthquake, the pipe joint can be damaged. In addition, the pipe joint can also be damaged because load bearing of a tensile load or shear stress or the like decreases due to deterioration of the rubber and such after using the pipe joint for an extended period of time.

On the other hand, Japanese Unexamined Utility Model Publication No. S59-13785, for example, discloses a pipe joint in which flanges provided on both ends of the pipe joint are coupled by a tie-rod so as to maintain a pipe length along an axial direction of the pipe joint constant and to improve strength for loads in the axial direction of the pipe joint.

However, while the disclosed pipe joint can suppress tensile loads in the axial direction of the pipe joint, it cannot flexibly address stress in a direction other than the axial direction due to a slant of the pipe. For example, when eccentricity of the pipe to be coupled occurs due to land subsidence, the pipe joint follows the eccentricity and becomes slanted, and consequently the tie-rod connected to the flange can be inflected. Moreover, because the slant of the pipe joint causes the pipe to be pulled toward the pipe joint, a strong force can be applied to the pipe joint, the pipe, and the tie-rod, possibly damaging these components.

### SUMMARY OF THE INVENTION

The present invention was made in view of the above problems. An object of the present invention is to provide a pipe joint that effectively accommodates a relative positional displacement between pipes, thereby allowing unfailing coupling between the pipes.

In order to address to the above problems, the present inventors found that it is possible to effectively accommodate a relative positional displacement between pipes while providing a predetermined strength by coupling a pair of flanges provided at both ends of the pipe joint using a string member, and thus completed the present invention. Specifically, the present invention provides pipe joints as described below.

A first aspect according to the present invention provides a pipe joint coupling a first pipe and a second pipe that face each other using an application bolt, the pipe joint including: a flexible pipe main body in a circular cylindrical shape; a pair of flanges that is provided on both ends of the pipe main body, and are coupled to end portions of the first pipe and the second pipe that face each other; and a plurality of string members that couple the flanges, wherein each string member includes a string main body, and a pair of stopping members that are provided on both ends of the string main body with a predetermined distance, and the flanges are formed in an annular shape, and include a plurality of flange pieces that are separated along lines radially extending from a substantial center, an ear portion provided on an end of each flange piece and having a coupling hole for coupling the flange pieces, a coupling bolt that is inserted through the coupling hole along a length direction of the pipe main body to couple the flange pieces, and an attachment hole through which the application bolt for coupling the first pipe and the second pipe, and at least one of the coupling bolt and the application bolt is provided with a through hole through which the string main body is inserted in the length direction, and a housing portion for housing the stopping member, the housing portion communicating with the through hole and having an opening area wider than that of the through hole.

The pipe joint of the first aspect according to the present invention is provided with a flexible pipe main body in a circular cylindrical shape; a pair of flanges provided on both ends the pipe main body, and which are coupled to end portions of the first pipe and the second pipe that face each other; and a plurality of string members that couple the flanges. With this, it is possible to unfailingly couple the first pipe and the second pipe that face each other via the pipe joint. Further, by using a flexible material for the pipe main body, the pipe main body becomes deformable when a relative positional displacement occurs between the pipes or when the deformation occurs due to the slant, it is possible to accommodate the displacement. Further, because the flanges are coupled using the string member, the string member can also accommodate the displacement, thereby making it possible to prevent damage to the string member.

The string member can be provided for one or both of the coupling bolts that couple the divided flange pieces and the application bolt that couples the first pipe and the second pipe that face each other with the pipe joint.

Further, the pipe joint couples the flange pieces by the insertion of the coupling bolt provided with the through hole and the housing portion into the coupling hole, and couples the pair of flanges by the insertion of the string member into the through hole of the coupling bolt and the stopping member housed within the housing portion. In this manner, the flange pieces are coupled using the coupling bolt, and the pair of flanges are coupled via the string member using this coupling bolt. Specifically, the coupling bolt serves as a member for coupling the flange pieces, as well as a member for coupling the pair of flanges. With this, it is possible to reduce the number of components for the pipe joint, thereby reducing the manufacturing cost. Furthermore, in the pipe joint, the pair of flanges and the pipe main body are not integrally formed, and instead, a flange that is dividable and constituted by a plurality of flange pieces is used to engage with the pipe main body. Accordingly, it is not necessary to form a complex metal mold, allowing mass production at low cost.

Further, the distance between the stopping members provided on both ends of the string member is greater than the distance between the pair of flanges. Therefore, even when the first pipe or the second pipe are displaced due to an earthquake or subsidence, for example, and the pipe main body of the pipe joint deforms to extend in an axial direction, it is possible to prevent the pipe joint from being damaged due to the extension, because the string member restricts the maximum amount of displacement of the pipe main body. In addition, even when the pipe joint flexes due to, for example, land subsidence or the like, it is possible to prevent the pipes from being pulled because the flanges coupled by the coupling bolt are provided to be slidable with respect to the string member, and the amount of displacement of the flanges becomes adjustable. With this, it is possible to prevent the pipe joint and the first pipe or the second pipe from being damaged.

Moreover, the stopping member is housed within the housing portion provided for the coupling bolt and/or the application bolt, and accordingly, the stopping member does not become an impediment during the handling work or after the attachment.

A second aspect according to the present invention provides a pipe joint coupling a first pipe and a second pipe that face each other using an application bolt, the pipe joint including: a flexible pipe main body in a circular cylindrical shape; a pair of flanges that is provided on both ends of the pipe main body, and which are coupled to end portions of the first pipe and the second pipe that face each other; and a plurality of string members that couple the flanges, wherein each string member includes a string main body, and a pair of stopping members that are provided on both ends of the string main body with a predetermined distance, the flanges are formed in an annular shape, and include an attachment hole for coupling the flange and the end portions of the first pipe and the second pipe, and an application bolt that is inserted through the attachment hole along a length direction of the pipe main body to couple the flange and the end portions of the first pipe and the second pipe, and the application bolt is provided with a through hole through which the string main body is inserted in the length direction, and a housing portion for housing the stopping member, the housing portion communicating with the, through hole and having an opening area wider than that of the through hole.

The pipe joint of the second aspect according to the present invention is provided with a flexible pipe main body in a circular cylindrical shape; a pair of flanges that is provided on both ends the pipe main body, and which are coupled to end portions of the first pipe and the second pipe that face each other; and a plurality of string members that couple the flanges. With this, by inserting the application bolt provided with the through hole through the attachment hole of each flange and the bolt hole of the first pipe and the second pipe, the pipe joint couples the first pipe and the second pipe with each flange. In addition, by inserting the string member through the through hole of the application bolt, and by housing the stopping member within the housing portion, the pair of flanges can be coupled, and the first pipe and the second pipe that face each other can be coupled without fail via the pipe joint. Further, by using a flexible material for the pipe main body, the pipe main body becomes deformable when a relative positional displacement occurs between the pipes or when the deformation occurs due to the slant, it is possible to accommodate the displacement. Further, because the flanges are coupled using the string member, the string member can also accommodate the displacement, thereby making it possible to prevent damage to the string member.

Further, the distance between the stopping members provided on the both ends of the string member is greater than the distance between the flanges. Therefore, as described above, even when the first pipe or the second pipe are displaced due an earthquake or subsidence, for example, and the pipe main body of the pipe joint deforms to extend in an axial direction, it is possible to prevent the pipe joint from being damaged due to the extension, because the string member restricts the maximum amount of displacement of the pipe main body. In addition, even when the pipe joint flexes due to, for example, land subsidence or the like, it is possible to prevent the pipes from being pulled because the flanges coupled with the pipes by the application bolt are provided to be slidable with respect to the string member, and the amount of displacement of the flanges becomes adjustable. With this, it is possible to prevent the pipe joint and the first pipe or the second pipe from being damaged.

Moreover, the stopping member is housed within the housing portion provided for the application bolt, and accordingly, the stopping member does not become an impediment during the handling work or after the attachment.

A third aspect according to the present invention provides a pipe joint coupling a first pipe and a second pipe that face each other using an application bolt, the pipe joint including: a flexible pipe main body in a circular cylindrical shape; a pair of flanges that is provided on both ends the pipe main body, and are coupled to end portions of the first pipe and the second pipe that face each other; and a plurality of string members that couple the flanges, wherein each string member includes a string main body, and a pair of stopping members that are provided on both ends of the string main body with a predetermined distance, the flanges are formed in an annular shape, and include a plurality of attachment holes for coupling the flange and the end portions of the first pipe and the second pipe, an attachment bolt hole provided at a middle portion of the attachment holes, and an attachment bolt that is inserted through the attachment bolt hole to attach the string member, and the application bolt is provided with a through hole through which the string main body is inserted in the length direction, and a housing portion for housing the stopping member, the housing portion communicating with the through hole and having an opening area wider than that of the through hole.

The pipe joint of the third aspect according to the present invention is provided with a flexible pipe main body in a circular cylindrical shape; a pair of flanges that is provided on both ends the pipe main body, and which are coupled to end portions of the first pipe and the second pipe that face each other; and a plurality of string members that couple the flanges. Moreover, the string member is inserted through the through hole of the attachment bolt inserted through the attachment bolt hole provided for the pair of flanges, and the stopping member is housed within the housing portion to couple the pair of flanges. Further, by using a flexible material for the pipe main body, the pipe main body becomes deformable when a relative positional displacement occurs between the pipes or when a deformation occurs due to slanting, it is possible to accommodate the displacement. Further, because the flanges are coupled using the string member, the string member can also accommodate displacements, thereby making it possible to prevent damage to the string member.

Further, as described above, the distance between the stopping members provided on both ends of the string member is greater than the distance between the head portions of the attachment bolts inserted through the attachment bolt holes that are provided at corresponding positions of the flanges. Therefore, as described above, even when the first pipe or the second pipe are displaced due an earthquake or subsidence, for example, and the pipe main body of the pipe joint deforms to extend in an axial direction, it is possible to prevent the pipe joint from being damaged due to the extension, because the string member restricts the maximum amount of displacement of the pipe main body. In addition, even when the pipe joint is flexes due to, for example, land subsidence or the like, it is possible to prevent the pipes from being pulled because the flanges coupled with the pipes by the application bolt are provided to be slidable with respect to the string member, and the amount of displacement of the flanges becomes adjustable. Thus, it is possible to prevent the pipe joint and the first pipe or the second pipe from being damaged.

Moreover, the stopping member is housed within the housing portion provided for the application bolt, and accordingly, the stopping member will not become an impediment during the handling work or after the attachment.

A fourth aspect according to the present invention provides the above pipe joint, where the stopping member is provided with an adjustment mechanism capable of adjusting the predetermined distance.

The stopping member of the fourth aspect according to the present invention is provided with an adjustment mechanism capable of adjusting the amount of displacement of the pipe joint. Accordingly, as described above, it is possible to adjust the amount of displacement according to the situation of an installation location and the quality of the flexible material used for the pipe main body, and to use the pipe joint in the same way in various locations. In addition, for example, in a case in which the flexible pipe main body is made of a material subject to deterioration such as rubber that can be easily damaged, it is possible to prevent the damage by setting the amount of displacement small to restrict the extension in the axial direction.

A fifth aspect according to the present invention provides the above pipe joint, where the adjustment mechanism includes a thread member that is fixed to both ends of the string main body, and a cap member threadable with the thread member, and the predetermined distance is adjusted by adjusting an amount of threading between the thread member and the cap member.

The adjustment mechanism (stopping member) of the fifth aspect according to the present invention is provided with the thread members and the cap members threadable with the thread members. The thread members are fixed to both ends of the string main body to thread the thread member with the cap member. By adjusting the amount of threading between the cap members and the thread members, it is possible to adjust the amount of displacement of the pipe joint. The thread members are fixed to the string main body with the predetermined distance from the flanges.

A sixth aspect according to the present invention provides the above pipe joint according to any of the first aspect to the fifth aspect, where the string main body is formed by twisting a plurality of wires.

The string main body of the sixth aspect according to the present invention is formed by twisting a plurality of wires. With this, it is possible to improve the strength for tensile loads and such occurring in the string main body. Accordingly, it is possible to maintain the first pipe and the second pipe constant even when the relative positional displacement of the pipes and the tensile load and the strain that the string main body can receive when flexed occur, allowing use for an extended period of time.

A seventh aspect according to the present invention provides the above pipe joint according to any of the first aspect to the sixth aspect, where the string main body is made of metal.

The string main body of the seventh aspect according to the present invention is made of metal. As described above, metal has ductility and tractility, and it is possible to prevent the string main body from breaking even in the case of a tensile load and strain arising when a relative positional displacement or flexing occur.

An eighth aspect according to the present invention provides the above pipe joint according to any of the first aspect to the seventh aspect, where the string main body is made of a wire rope.

The string main body of the eighth aspect according to the present invention is made of a wire rope. As described above, because the wire rope is used for the string main body, it is possible to prevent disconnection due to bending fatigue and such from occurring. With this, it is possible to improve the durability of the string member, allowing the use for an extended period of time.

A ninth aspect according to the present invention provides the above pipe joint according to any of the first aspect to the eighth aspect, where each flange is provided with a plurality of recesses.

The flange of the ninth aspect according to the present invention is provided with the plurality of recesses. With this, it is possible to reduce the weight of the flange by the recesses. Therefore, it is possible to reduce the weight of the entire pipe joint as a whole.

According to the present invention, it is possible to provide a pipe joint that effectively accommodates a relative positional displacement between pipes, thereby allowing unfailing coupling between the pipes.

### BRIEF DESCRIPTION OF THE DRAWINGS

FIG. 1 shows an elevational view of a pipe joint according to a first embodiment of the present invention;

FIG. 2 shows a cross-sectional view taken along line A-A in FIG. 1;

FIG. 3 shows an exploded perspective view of a coupling wire according to the first embodiment, having an adjustment mechanism;

FIG. 4 shows a partially enlarged view of the adjustment mechanism of the coupling wire as shown in FIG. 3;

FIG. 5 shows an exploded view illustrating another aspect of the coupling wire as shown in FIG. 3;

FIG. 6 shows an exploded perspective view of a coupling wire according to the first embodiment without an adjustment mechanism;

FIG. 7 shows an exploded view illustrating another aspect of the coupling wire as shown in FIG. 6;

FIG. 8 shows a cross-sectional view illustrating the pipe joint according to the first embodiment attached to a first pipe and a second pipe;

FIG. 9 shows a cross-sectional view illustrating another aspect in which an application bolt in place of a coupling bolt in FIG. 8 is provided with a string member;

FIG. 10 shows a cross-sectional view illustrating another aspect in which each of the coupling bolt and the application bolt in FIG. 8 is provided with the string member;

FIG. 11 shows an elevational view of a pipe joint according to a second embodiment of the present invention;

FIG. 12 shows a cross-sectional view illustrating the pipe joint according to the second embodiment attached to a first pipe and a second pipe;

FIG. 13 shows an elevational view of a pipe joint according to a third embodiment of the present invention;

FIG. 14 shows a cross-sectional view taken along line B-B in FIG. 13;

FIG. 15 shows a plan view illustrating a case in which a relative positional displacement between a first pipe and a second pipe according to the third embodiment occurs; and

FIG. 16 shows a plan view illustrating the state in which the relative position between the first pipe and the second pipe according to the third embodiment is slanted.

### DETAILED DESCRIPTION OF THE INVENTION

The following describes embodiments of the present invention with reference to the drawings. The embodiments of the present invention are not particularly limited to the embodiments described below, and the technical scope of the present invention is not limited by the described embodiments. In addition, in the description of the embodiments, similar components are indicated by similar numerals and descriptions of these components are omitted or simplified.

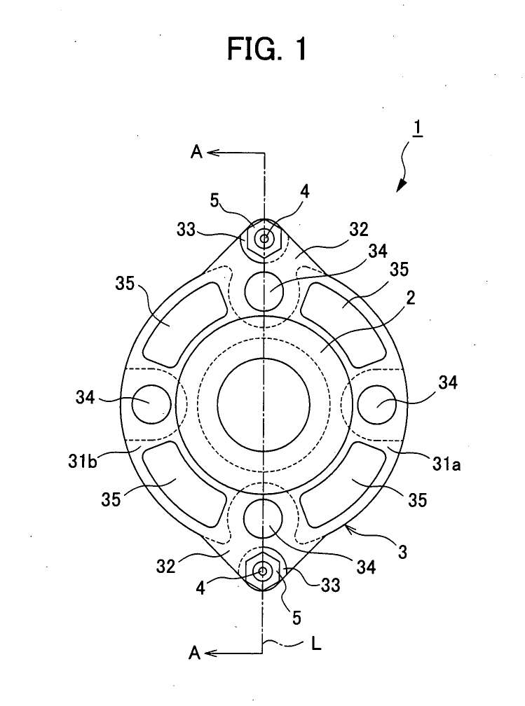

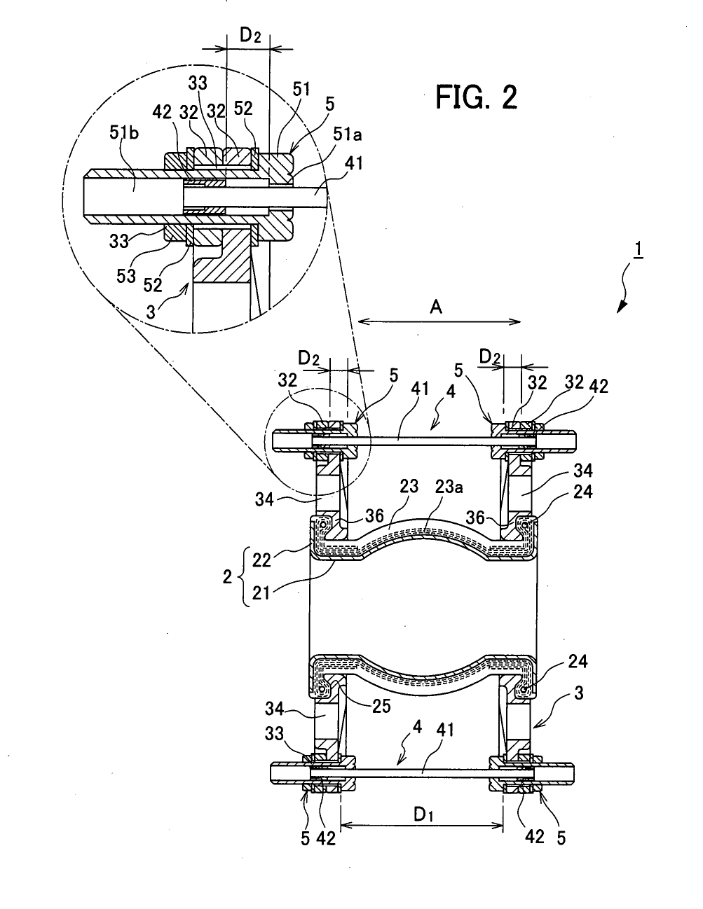

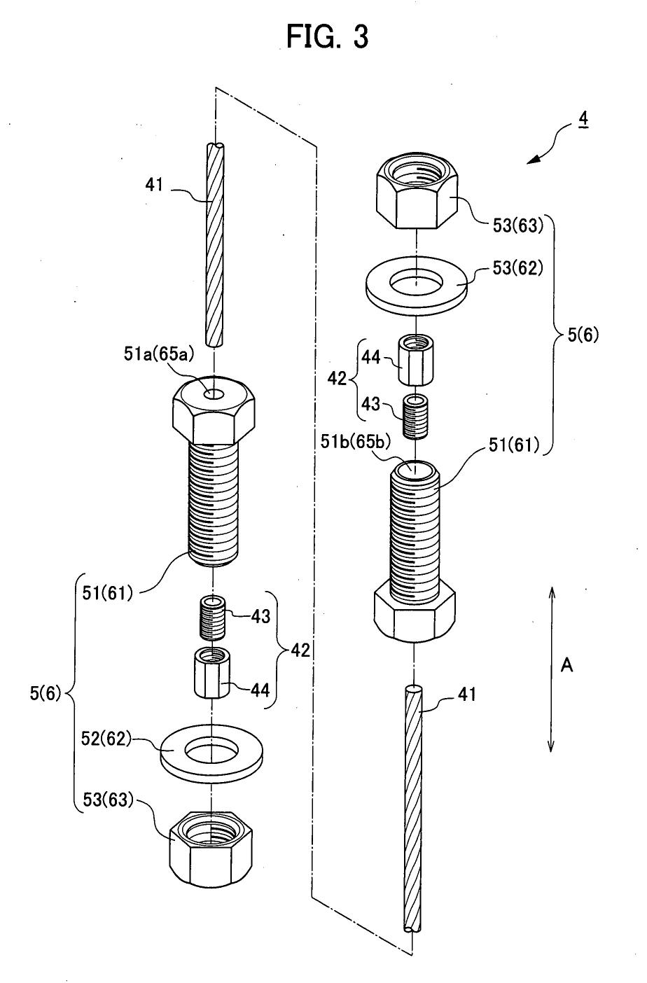

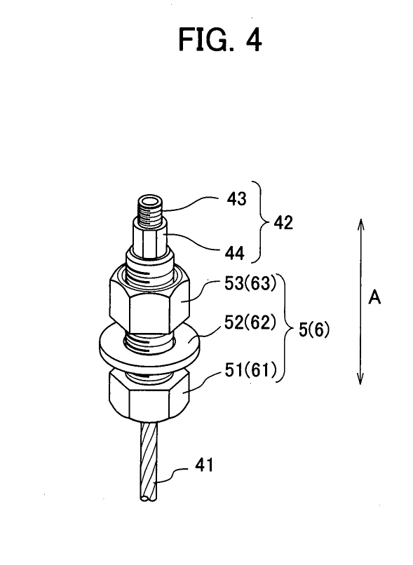

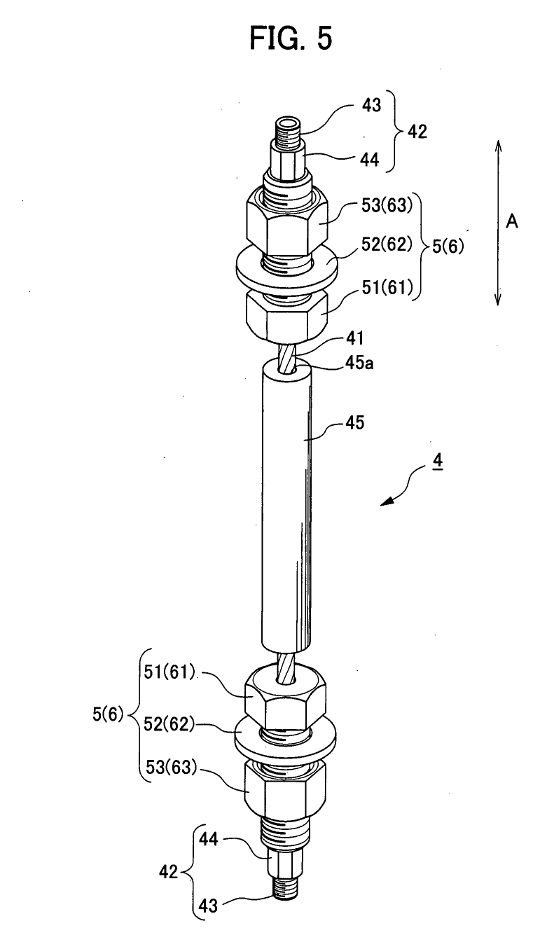

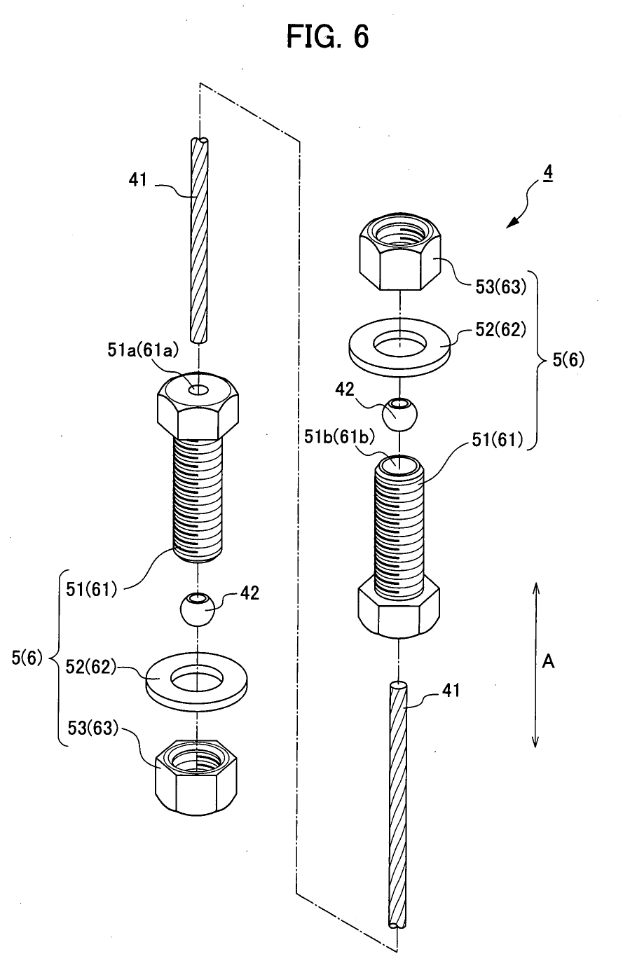

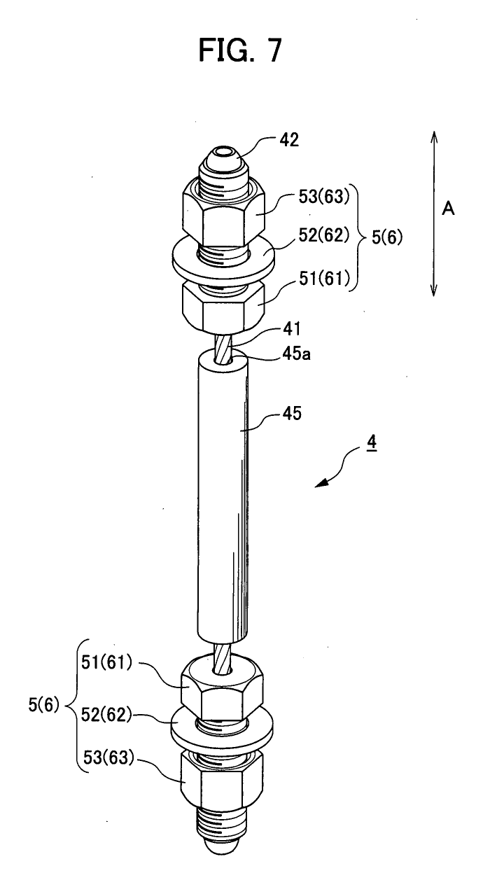

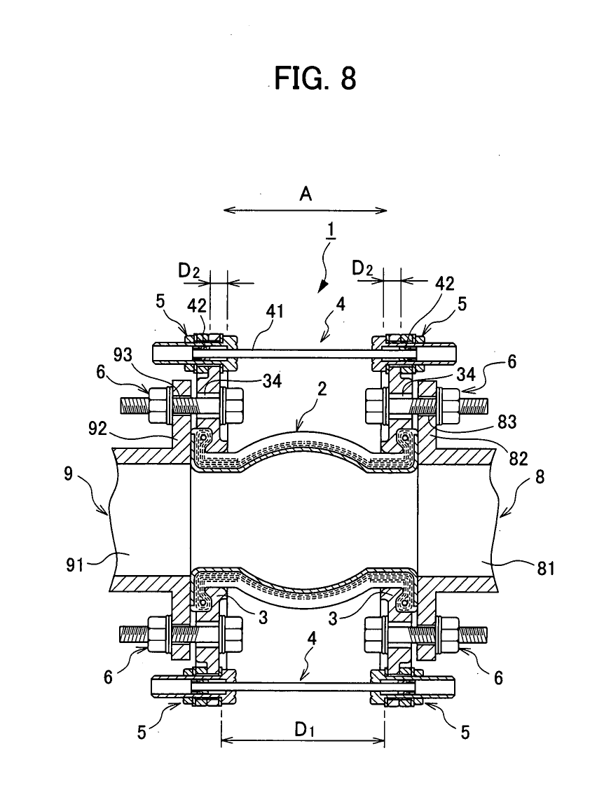

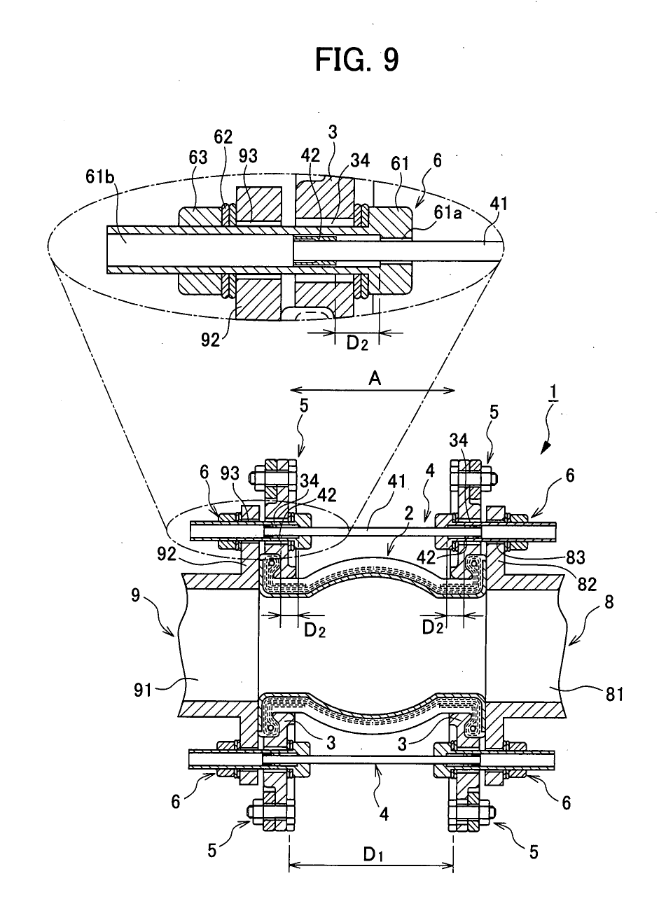

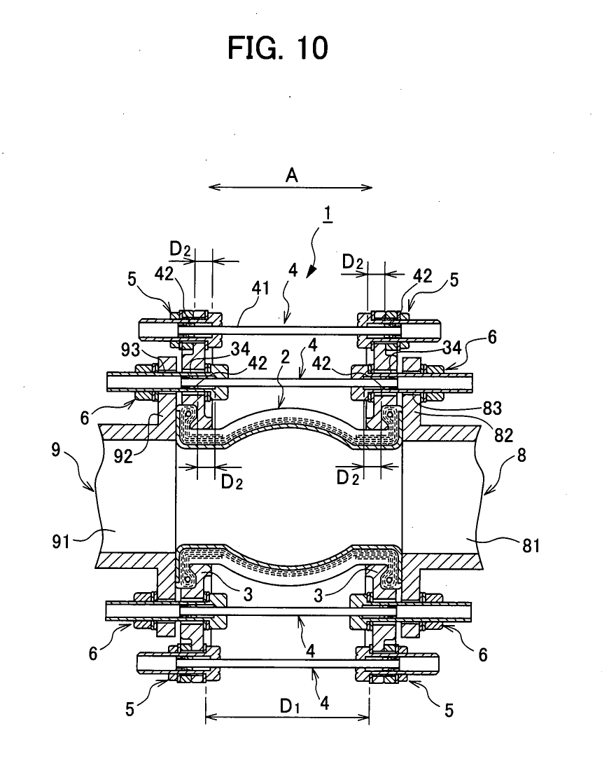

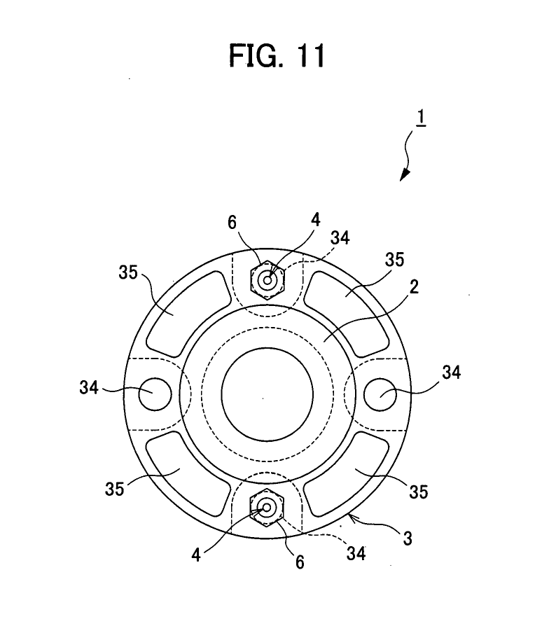

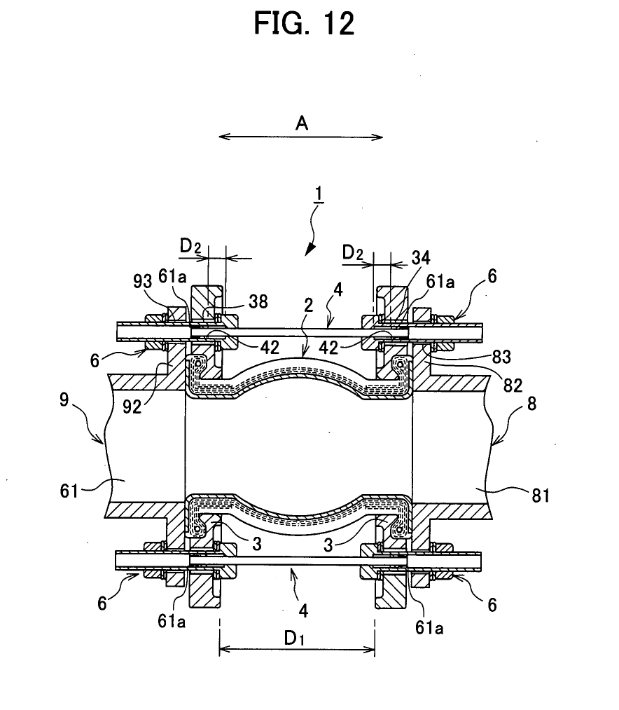

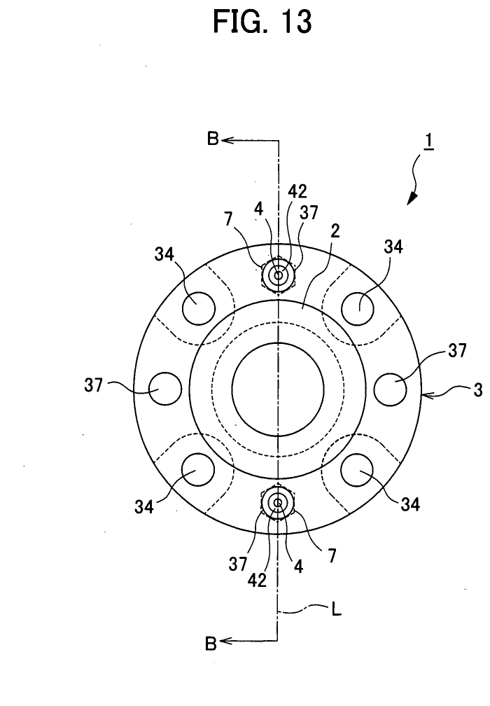

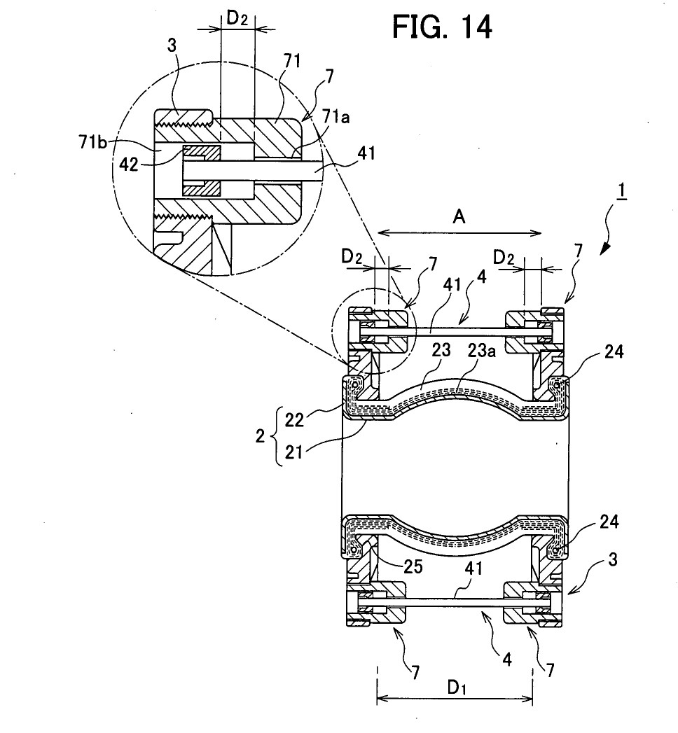

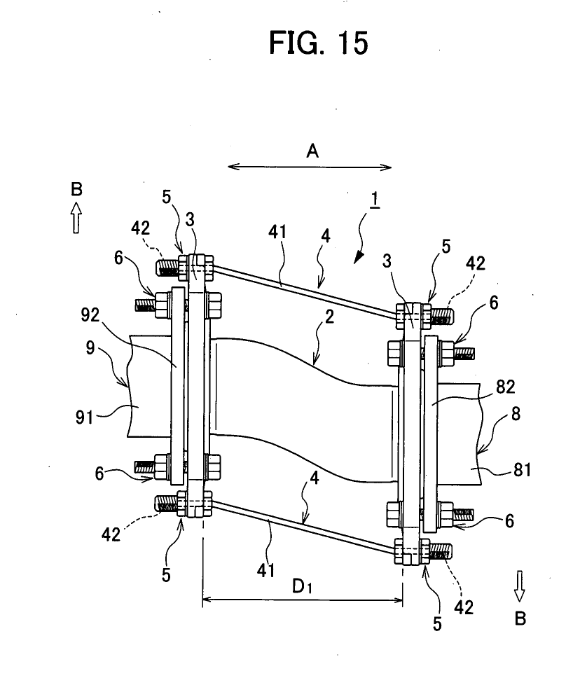

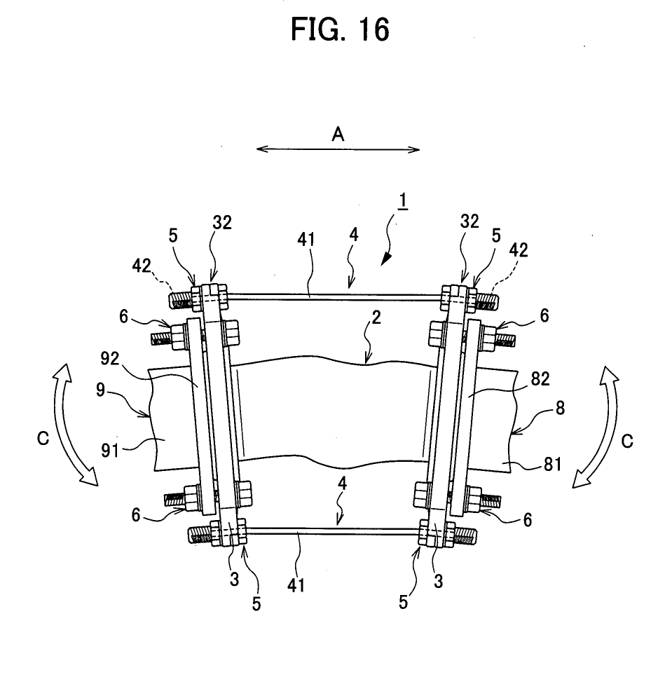

FIG. 1 shows an elevational view of a pipe joint according to a first embodiment of the present invention. FIG. 2 shows a cross-sectional view taken along line A-A in FIG. 1. FIG. 3 shows an exploded perspective view of a coupling wire according to the first embodiment, having an adjustment mechanism. FIG. 4 shows a partially enlarged view of the adjustment mechanism of the coupling wire as shown in FIG. 3. FIG. 5 shows an exploded view illustrating another aspect of the coupling wire as shown in FIG. 3. FIG. 6 shows an exploded perspective view of a coupling wire according to the first embodiment without an adjustment mechanism. FIG. 7 shows an exploded view illustrating another aspect of the coupling wire as shown in FIG. 6. FIG. 8 shows a cross-sectional view illustrating the pipe joint according to the first embodiment attached to a first pipe and a second pipe. FIG. 9 shows a cross-sectional view illustrating another aspect in which an attachment bolt in place of a coupling bolt in FIG. 8 is provided with a string member. FIG. 10 shows a cross-sectional view illustrating another aspect in which each of the coupling bolt and the attachment bolt in FIG. 8 is provided with the string member. FIG. 11 shows an elevational view of a pipe joint according to a second embodiment of the present invention. FIG. 12 shows a cross-sectional view illustrating the pipe joint according to the second embodiment attached to a first pipe and a second pipe. FIG. 13 shows an elevational view of a pipe joint according to a third embodiment of the present invention. FIG. 14 shows a cross-sectional view taken along line B-B in FIG. 13. FIG. 15 shows a plan view illustrating a case in which a relative positional displacement between a first pipe and a second pipe according to the third embodiment occurs. FIG. 16 shows a plan view illustrating the state in which the relative position between the first pipe and the second pipe according to the third embodiment is slanted.

### First Embodiment

As shown in FIG. 1 and FIG. 2, a pipe joint 1 according to a first embodiment of the present invention is provided with a flexible pipe main body 2 as a pipe main body, a pair of flanges 3 provided for both ends of the flexible pipe main body 2, respectively, and two coupling wires 4 as string members.

The flexible pipe main body 2 is formed in a substantially circular cylinder shape, and is provided with a tubular portion 21 and a guard portion 22 provided on both ends of the tubular portion 21. The tubular portion 21 is formed such that an approximately central portion of the tubular portion 21 in an axial direction A protrudes in a direction that is perpendicular with the axial direction A. Specifically, an outer periphery of the tubular portion 21 in a axial cross-section swells in an inverted V shape. While the flexible pipe main body 2 is configured such that the outer periphery of the flexible pipe main body in the axial cross-section is in the inverted V shape in this embodiment, the present invention is not limited to this example, and the outer periphery of the flexible pipe main body may be formed to have a shape that allows an increased flexibility of the flexible pipe main body 2, such as a wave pattern (bellows shape).

The tubular portion 21 and the guard portion 22 are integrally formed by an elastic member 23 such as rubber in which a tire cord (reinforcement fiber) 23a such as nylon or polyester is embedded. Further, a reinforcement ring 24 made of metal is embedded in the guard portion 22. With this configuration, the flexible pipe main body 2 constituted by the tubular portion 21 and the guard portion 22 is provided with flexibility by the elastic member 23 as well as a predetermined pressure resistance. It is desirable that an inner wall of the elastic member 23 that is made a rubber layer such as synthetic rubber is coated by a material having superior heat resistance and chemical resistance such as fluorine contained resin. In addition, a reinforcement ring made of metal may be embedded in the rubber layer.

The flange 3 is formed in an annular shape, and provided with two circular arc shaped flange pieces 31a, 31b, a coupling hole 33 for coupling each of the flange pieces 31a, 31b, an ear portion 32 at which the coupling hole 33 is provided, a coupling bolt 5 inserted through the coupling hole 33 to couple each of the flange pieces 31a, 31b, an attachment hole 34 as a fastening hole for attaching the flange to pipe guard portions 82, 92 for a first pipe 8 and a second pipe 9 that are later described, and a recess 35 that is thinly formed.

The flange 3 is formed by the two flange pieces 31a, 31b divided along a line L that extends radially from a center of the flange 3. Each of the flange pieces 31a, 31b is provided with an engagement portion 36 that is formed thinly and engageably with the guard portion 22 of the flexible pipe main body 2 along an inner periphery of each flange piece. In this engagement portion 36, the guard portion 22 of the flexible pipe main body 2 is engaged with the flange pieces 31a, 31b. The engagement between the guard portion 22 of the flexible pipe main body 2 and each of the flange pieces 31a, 31b is not limited to this example. The engagement portion 36 can take any shape as long as each of the flange pieces 31a, 31b is engaged with the guard portion 22.

The ear portion 32 is provided at both ends of the flange pieces 31a, 31b, respectively. The ear portion 32 includes the coupling hole 33. The coupling hole 33 is formed by these ear portions 32 being overlapped and communicate with each other. Specifically, the ear portion 32 configured to protrude outside with a thickness that is about a half of a thickness of the flange pieces 31a, 31b, and the coupling holes 33 of the respective the ear portions 32 are communicated by overlapping adjacent ear portions 32 in a thickness direction. The flange pieces 31a, 31b form the flange 3 in the annular shape by coupling the coupling hole 33 provided for the ear portion 32 using the coupling bolt 5.

The attachment holes 34 are provided for each of the flange pieces 31a, 31b at a predetermined interval. In this embodiment, three attachment holes 34 are provided for each of the flange pieces 31a, 31b: a single circular hole at a substantial center of the flange pieces 31a, 31b, and two semicircular holes at each side of the circular hole. Two semicircular holes form a single circular hole when the flange pieces 31a, 31b are coupled together. An application bolt 6 that is later described is inserted through the attachment hole 34 so as to couple the first pipe 8 and the second pipe 9 with the pipe joint 1.

The recess 35 is disposed between the attachment holes 34, in a manner recessed in a thickness direction of the flange pieces 31a, 31b. The recess 35 is designed to reduce the weight of the flange pieces 31a, 31b.

The coupling bolt 5 includes a bolt member 51, a washer member 52, and a nut member 53. The flange pieces 31a, 31b are coupled together by inserting the bolt member 51 of the coupling bolt 5 through the coupling hole 33 and sandwiching the washer member 52 to engage with the nut member 53. By this, the flange pieces 31a, 31b are integrated to form the flange 3 in an annular shape. Further, the bolt member 51 of the coupling bolt 5 is provided with a through hole 51a through which a wire rope 41 as a string main body of the later described string member can be inserted on a tip end side, and a housing portion 51b communicating with the through hole 51a and having an opening area wider than that of the through hole 51a in a length direction. In addition, an inner diameter of the through hole 51a is formed to be smaller than an outer diameter of an adjustment cap of the coupling wire of the later described string member so that the wire rope 41 does not fall out of the coupling bolt 5 (see FIG. 2). The enlarged view of FIG. 2 shows how the side stoppers 42 of the coupling wire 4 are housed relative to the coupling bolt 5.

As shown in FIG. 3 and FIG. 4, the coupling wire 4 is provided with the wire rope 41 that is the string main body formed by twisting a plurality of metal wires, and with the side stoppers 42 that are stoppers provided at both ends of the wire rope 41. The wire rope 41 is inserted through the through hole 51a of each coupling bolt 5. Then, the coupling bolt 5 is coupled with the flange 3 in a state in which the wire rope 41 is inserted through the through hole 51a of each coupling bolt 5 and in which the side stoppers 42 is housed in the housing portion 51b. By this, the flanges 3 of the pipe joint 1 are coupled by the coupling wire 4.

At both ends of the wire rope 41, the side stoppers 42 that are stopper so that the wire rope 41 does not fall out, are provided away from the through hole 51a of the coupling bolt 5 at a predetermined distance D₂ (opposite direction of the flexible pipe main body in the axial direction A) (see the enlarged view in FIG. 2). The side stoppers 42 are provided with engaging threads 43 as thread members and an adjustment cap 44 as a cap member. The engaging threads 43 are fixed to both ends of the wire rope 41, respectively. The engaging thread 43 has male threads. The adjustment cap 44 has female threads inside, and threaded with the engaging thread 43 having male threads. With this, a distance between the side stoppers 42 as stoppers can be adjusted by threading the adjustment cap 44 into the engaging thread 43 as thread member. The side stoppers 42 are provided with the adjustment mechanism.

The predetermined distance D₂ is provided to, when the first pipe 8 or the second pipe 9 subsides due to land subsidence due to an earthquake or the like or when a predetermined slant occurs in the first pipe 8 or the second pipe 9 for example, accommodate a positional displacement due to the subsidence or deformation of an angle due to the slant, to absorb an extension of the flexible pipe main body 2, as well as to maintain the distance D₁ between the flanges 3 within a predetermined range (see FIG. 2). The predetermined distance D₂ can be adjusted by the amount of threading between the engaging thread 43 and the adjustment cap 44 in the side stoppers 42. In addition, the predetermined distance D₂ can be appropriately selected within a range of an amount of extension in which the flexible pipe main body 2 is not damaged, in accordance with the design of the properties of the flexible pipe main body 2 or the displacement to be absorbed.

Further, as shown in FIG. 5, a center stopper 45 can be provided between the bolt member 51 and the other bolt member 51. The center stopper 45 includes a through hole 45a, and the wire rope 41 is inserted through the through hole 45a and attached. The distance between the bolt member 51 and the other the bolt member 51 is restricted by providing the center stopper 45. Accordingly, the flanges 3 are not excessively pulled from each other due to the positional displacement, thereby preventing the pipe joint 1 from being crushed, or the first pipe 8 and the second pipe 9 from being damaged due to too much strain. The center stopper 45 is a member having a rod shape or the like of a predetermined length that is shorter than the pipe joint 1, and freely movable between the bolt member 51 and the other bolt member 51.

The coupling wire 4 as the string member is not limited to the example provided with the above adjustment function. For example, the coupling wire 4 can be as shown in FIG. 6. The coupling wire 4 as shown in FIG. 6 is provided with the wire rope 41 as the string main body formed by twisting the plurality of metal wires, and the side stoppers 42 that are stoppers provided at both ends of the wire rope 41. Further, the side stoppers 42 are fixed to the wire rope 41 with a fixing means such as welding. As described above, the side stoppers 42 may not necessarily be provided with the adjustment function. In addition, as shown in FIG. 7, the center stopper 45 can be provided between the bolt member 51 and the other bolt member 51.

Further, while the string main body of the string member is a wire rope in this embodiment, the string main body is not limited to this example as long as the material has strength to resist tensile force and is deformable, and a wire, for example, can be used. When the wire is used, a tip end of the wire can be directly threaded instead of providing the engaging thread 43 at the tip end of the wire. By directly threading, it is possible to reduce the number of components. Further, because the engagement of the engaging thread 43 and the bolt member 51 is resolved, it is possible to adjust the amount of displacement only with the engagement between the adjustment cap 44 and the bolt member 51, thereby increasing the amount of maximum displacement of the pipe joint 1.

As shown in FIG. 8, the pipe joint 1 couples the first pipe 8 with the second pipe 9 that face each other. Each of the first pipe 8 and the second pipe 9 is provided with pipe tube portions 81, 91 and the pipe guard portions 82, 92. The pipe guard portions 82, 92 include the bolt holes 83, 93, respectively. By inserting the application bolt 6 through each of the bolt holes 83, 93 and the attachment hole 34, and fixing, the first pipe 8 and the second pipe 9 are coupled via the pipe joint 1.

Next, specific procedures for attaching the pipe joint 1 to the first pipe 8 and the second pipe 9 are described.

First, the wire rope 41 is inserted through each of the through holes 51a that are provided for the bolt members 51 of the pair of the coupling bolts 5, the engaging thread 43 of the side stoppers 42 is fixed by welding or the like at a predetermined position, for example, a position away from the through hole 51a of the coupling bolt 5 (opposite direction of the flexible pipe main body in the axial direction A) by the predetermined distance D₂, that is, so that a distance between the side stoppers 42 is (distance D₁ between flanges 3+predetermined distance D₂×2). The diameter of the through hole 51a is formed to be smaller than the outer diameter of the side stoppers 42, that is, the outer diameter of the adjustment cap 44 when the adjustment cap 44 is attached to the engaging thread 43. The inner diameter of the housing portion 51b provided for the bolt member 51 is formed to be greater than the outer diameter of the side stoppers 42, that is, the outer diameter of the adjustment cap 44 when the adjustment cap 44 is attached to the engaging thread 43. With this, a configuration is realized with which the side stoppers 42 are housed within the housing portion 51b, and do not fall out of the through hole 51a (see FIG. 2).

Next, the flange pieces 31a, 31b are combined to form the annular shape so that the corresponding ear portions 32 formed at the ends of the flange pieces 31a, 31b overlap each other, while the guard portions 22 provided for the both ends of the flexible pipe main body 2 are sandwiched by the flange pieces 31a, 31b in the circular arch shape, respectively. With this, the guard portions 22 are engaged with the engagement portions 36 of the flexible pipe main body 2 of the flange pieces 31a, 31b.

Then, the bolt member 51 attached with the coupling wire 4 is inserted through each of the coupling holes 33 provided for the ear portions 32, to sandwich the washer member 52 to be threaded with the nut member 53. With this, the flange pieces 31a, 31b are integrated to form the flange 3. Specifically, the pair of flanges 3 are formed on the both ends of the flexible pipe main body 2. With this, the flanges 3 are coupled by the coupling wire 4 via the coupling bolt 5.

Subsequently, the pipe joint 1 in which the flanges 3 are coupled by the coupling wire 4 is positioned between the first pipe 8 and the second pipe 9 such that the attachment hole 34 of the flange 3 and the bolt holes 83, 93 of the pipe guard portions 82, 92 are communicated, and a bolt member 61 of the application bolt 6 is inserted through each of the attachment hole 34 and the bolt holes 83, 93, to sandwich the washer member 62 to be threaded with a nut member 63. With this, the flange pieces 31a, 31b are integrated to form the flange 3. With this, the first pipe 8 and the second pipe 9 are coupled via the pipe joint 1.

### Another Aspect of First Embodiment

Next, another aspect in which the string member 4 is provided for the application bolt 6 is described with reference to FIG. 9.

In this embodiment, a through hole 61a and a housing portion 61b are provided for the application bolt 6 instead of the coupling bolt 5. As shown in FIG. 9, the coupling wire 4 as the string member couples between the flanges 3 such that the wire rope 41 is inserted through the through hole 61a of the application bolt 6 that couples the pipe joint 1, and the first pipe 8 and the second pipe 9, and the side stoppers 42 are housed within the housing portion 61b. That is, as shown in FIG. 3, the bolt member 61 of the application bolt 6 is provided with the through hole 61a that penetrates along the axial direction A as for of the bolt member 51 of the coupling bolt 5 of the first embodiment, and the housing portion 61b communicating with the through hole 61a and having an opening area wider than that of the through hole 61a. With this, the wire rope 41 of the coupling wire 4 is inserted through the through hole 61a, and the side stoppers 42 couple between the flanges 3 in a state in which the side stoppers 42 are housed in the housing portion 61b.

Next, specific procedures for attaching the pipe joint 1 to the first pipe 8 and the second pipe, and attachment procedures of the coupling wire 4 are described with reference to FIG. 9.

First, the wire rope 41 is inserted through each of the through holes 61a that are provided for the bolt member 61 of the pair of the application bolt 6, the engaging thread 43 of the side stoppers 42 is fixed by such as welding at a predetermined position, for example, a position away from the through hole 61a of application bolt 6 (opposite direction of the flexible pipe main body in the axial direction A) by the predetermined distance D₂, that is, so that a distance between the side stoppers 42 is (distance D₁ between flanges 3+predetermined distance D₂×2). The diameter of the through hole 61a is formed to be smaller than the outer diameter of the side stoppers 42, that is, the outer diameter of the adjustment cap 44 when the adjustment cap 44 is attached to the engaging thread 43. The inner diameter of the housing portion 51b provided for the bolt member 51 is formed to be greater than the outer diameter of the side stoppers 42, that is, the outer diameter of the adjustment cap 44 when the adjustment cap 44 is attached to the engaging thread 43. With this, a configuration is realized with which the side stoppers 42 are housed within the housing portion 51b, and do not fall out of the through hole 51a (see FIG. 2). The enlarged view of FIG. 9 shows how the side stoppers 42 of the coupling wire 4 are housed relative to the application bolt 6.

Subsequently, the pipe joint 1 in which the flanges 3 are coupled by the coupling wire 4 is positioned between the first pipe 8 and the second pipe 9 such that the attachment hole 34 of the flange 3 and the bolt holes 83, 93 of the pipe guard portions 82, 92 are communicated, and a bolt member 61 of the application bolt 6 attached with the coupling wire 4 is inserted through each of the attachment hole 34 and the bolt holes 83, 93, to sandwich the washer member 62 to be threaded with a nut member 63. With this, the flange pieces 31a, 31b are integrated to form the flange 3. With this, the first pipe 8 and the second pipe 9 are coupled via the pipe joint 1. In addition, the pair of flanges 3 are coupled by the coupling wire 4.

### Yet Another Aspect of First Embodiment

Next, yet another aspect in which the string member 4 is provided for the coupling bolt 5 and the application bolt 6 is described with reference to FIG. 10.

In this embodiment, the through hole 51a and the housing portion 51b are provided for the coupling bolt 5, and the through hole 61a and the housing portion 61b are provided for the application bolt 6. As shown in FIG. 10, the coupling wire 4 as the string member is inserted through the through hole 51a of the coupling bolt 5 that couples between a flange piece 31a and a the flange piece 31b, the side stoppers 42 are housed within the housing portion 51b, the coupling wire 4 is inserted through the through hole 61a of the application bolt 6 that couples the pipe joint 1 with the first pipe 8 and the second pipe 9, and the side stoppers 42 are housed within the housing portion 51b to couple between the flanges 3. That is, as shown in FIG. 3, the bolt member 51 of the coupling bolt 5 is provided with the through hole 51a that penetrates along the axial direction A, and the housing portion 51b communicating with the through hole 51a and having an opening area wider than that of the through hole 51a. The coupling wire 4 is inserted through the through hole 51a, and the side stoppers 42 are housed within the housing portion 51b to couple between the flanges 3. Further, the bolt member 61 of the application bolt 6 is provided with the through hole 61a that penetrates along the axial direction A, and the housing portion 61b communicating with the through hole 61a and having an opening area wider than that of the through hole 61a. The coupling wire 4 is inserted through the through hole 61a, and the side stoppers 42 are housed within the housing portion 61b to couple between the flanges 3.

Procedures for attaching the pipe joint 1 to the first pipe 8 and the second pipe, and attachment procedures of the coupling wire 4 are the same as explained in the first embodiment and the other aspect of the first embodiment, and therefore the description is omitted.

### Second Embodiment

Next, a second embodiment of the pipe joint of the present invention is described. The pipe joint 1 according to the second embodiment of the present invention includes a flange 3 having an annular shape, that is not divided into two circular arc shaped flange pieces 31a, 31b of the pair of flanges 3 provided for the both ends of the flexible pipe main body 2 in the first embodiment as described above (see FIG. 11)., and as shown in FIG. 12, the coupling wire 4 as the string member is, as in the other aspect of the first embodiment, inserted into the through hole 61a of the application bolt 6 that couples the pipe joint 1 with the first pipe 8 and the second pipe 9, and the side stoppers 42 are housed within the housing portion 61b to provide coupling between the flanges 3. Specifically as shown in FIG. 3, the bolt member 61 of the application bolt 6 is provided with, as in the case of the bolt member 51 of the coupling bolt 5 according to the first embodiment, the through hole 61a through which the wire rope 41 can be inserted through the string main body of the string member on the tip end side, and the housing portion 61b communicating with the through hole 61a and having an opening area wider than that of the through hole 61a in a length direction. The coupling wire 4 is inserted through the through hole 61a, and the side stoppers 42 are housed within the housing portion 61b to couple the flanges 3. The flexible pipe main body 2 as the pipe main body has the same geometry and configuration as the first embodiment.

The flange 3 is provided with, as in the first embodiment, the attachment holes 34 at a predetermined distance. Four attachment holes 34 are provided respectively at positions dividing the flange 3 substantially in quarters. The application bolt 6 later described is inserted through the attachment hole 34 (see FIG. 11).

Further, the recess 35 is provided at a middle portion between the adjacent attachment holes 34 in a manner recessed in a thickness direction of the flange 3. The recess 35 is designed to reduce the weight of the flange 3 (see FIG. 11).

The coupling wire 4 is provided with the wire rope 41 that is the string main body formed by twisting a plurality of metal wires as in the first embodiment, and the side stoppers 42 that are stoppers provided at both ends of the wire rope 41 (see FIG. 3). The side stoppers 42 as stoppers are provided with an adjustment mechanism similar to that in the first embodiment (see FIG. 4). Further, as shown in FIG. 5, a center stopper 45 can be provided between the application bolt 6 and the other application bolt 6. The coupling wire 4 is not limited to this example, and may not necessarily be provided with the adjustment function as shown in FIG. 6 and FIG. 7.

The application bolt 6 includes the bolt member 61, the washer member 62, and the nut member. The application bolt 6 couples the flange 3 with a pipe guard portion 82 or a pipe guard portion 92 by inserting the bolt member 61 through the attachment hole 34 of the flange 3, and a bolt hole 83 of the first pipe 8 or a bolt hole 93 of the second pipe 9, and by sandwiching the washer member 62 to be threaded with the nut member 63. With this, the first pipe 8 and the second pipe 9 are coupled via the pipe joint 1. Further, the bolt member 61 is provided with the through hole 61a that penetrates in the axial direction A (see FIG. 3).

The coupling wire 4 is attached to the flange 3 in the same manner as in the first embodiment.

As described in the other aspect of the first embodiment, first, the wire rope 41 is inserted through each of the through hole 61a that are provided for the bolt member 61 of the pair of the application bolt 6, the engaging thread 43 of the side stoppers 42 is fixed by such as welding at a predetermined position, for example, a position away from the through hole 61a of application bolt 6 (opposite direction of the flexible pipe main body in the axial direction A) by the predetermined distance D₂, that is, so that a distance between the side stoppers 42 is (distance D₁ between flanges 3+predetermined distance D₂×2). The diameter of the through hole 61a is formed to be smaller than the outer diameter of the side stoppers 42, that is, the outer diameter of the adjustment cap 44 when the adjustment cap 44 is attached to the engaging thread 43. The inner diameter of the housing portion 51b provided for the bolt member 51 is formed to be greater than the outer diameter of the side stoppers 42, that is, the outer diameter of the adjustment cap 44 when the adjustment cap 44 is attached to the engaging thread 43. With this, a configuration is realized with which the side stoppers 42 are housed within the housing portion 51b, and do not fall out of the through hole 51a (see FIG. 12).

Subsequently, the pipe joint 1 in which the flanges 3 are coupled by the coupling wire 4 is positioned between the first pipe 8 and the second pipe 9 such that the attachment hole 34 of the flange 3 and the bolt holes 83, 93 of the pipe guard portions 82, 92 are communicated, and a bolt member 61 of the application bolt 6 is inserted through each of the attachment hole 34 and the bolt holes 83, 93, to sandwich the washer member 62 to be threaded with a nut member 63. With this, the flange pieces 31a, 31b are integrated to form the flange 3. With this, the first pipe 8 and the second pipe 9 are coupled via the pipe joint 1. In addition, the pair of flanges 3 are coupled by the coupling wire 4.

### Third Embodiment

Next, a third embodiment of the pipe joint of the present invention is described. The pipe joint 1 according to the second embodiment of the present invention includes a flange 3 having an annular shape that is not divided into two circular arc shaped flange pieces 31a, 31b, instead of the pair of flanges 3 provided for both ends of the flexible pipe main body 2 in the first embodiment as described above (see FIG. 13). and as shown in FIG. 14, the coupling wire 4 as the string member is inserted into a through hole 71a formed on a head side of a bolt member 71 of an attachment bolt 7, and the side stoppers 42 are housed within a housing portion 71b to couple between the flanges 3. Specifically, the bolt member 71 of the attachment bolt 7 is provided with, as in the case of the bolt member 51 of the coupling bolt 5 according to the first embodiment, the through hole 71a through which the wire rope 41 can be inserted through the string main body of the string member on the tip end side, and the housing portion 71b communicating with the through hole 71a and having an opening area wider than that of the through hole 71a in a length direction. The coupling wire 4 is inserted through the through hole 71a, and the side stoppers 42 is housed within the housing portion 71b to couple the flanges 3. The flexible pipe main body 2 as the pipe main body has the same geometry and configuration as the first embodiment.

The flange 3 is provided with, as in the first embodiment, the attachment holes 34 at a predetermined distance. Four attachment holes 34 are provided respectively at positions dividing the flange 3 substantially into quarters. Further, the bolt hole 37 for threading the attachment bolt 7 to attach the coupling wire 4 as the string member is provided at a middle portion between the adjacent attachment holes 34 (see FIG. 13). The attachment bolt hole 37 is a female thread hole for fixing the attachment bolt 7 by threading.

Further, although not shown in the drawing, a recess may be provided between the attachment hole 34 and the attachment bolt hole 37 in a manner recessed in a thickness direction of the flange 3. With this, it is possible to reduce the weight of the flange 3.

The coupling wire 4 is provided with the wire rope 41 that is the string main body formed by twisting a plurality of metal wires as in the first embodiment, and the side stoppers 42 that are stoppers provided at both ends of the wire rope 41 (see FIG. 3). The side stoppers 42 as stoppers are provided with the adjustment mechanism similar to that in the first embodiment (see FIG. 4). Further, as shown in FIG. 5, a center stopper 45 can be provided between the attachment bolt 7 and the other attachment bolt 7. The coupling wire 4 is not limited to this example, and may not necessarily be provided with the adjustment function as shown in FIG. 6 and FIG. 7.

The attachment bolt 7 is fixed to the flange 3 by threading with the attachment bolt hole 37 (see FIG. 14). The attachment to the flange 3 is not limited to this, and, for example, the attachment bolt 7 may include a bolt member, a washer member, and a nut member, and the bolt member may be inserted through the attachment bolt hole 37, and be threaded with the nut member while sandwiching the washer member, thereby fixing the attachment bolt 7 to the flange 3.

The coupling wire 4 is attached to the flange 3 in the same manner as in the first embodiment.

First, the wire rope 41 is inserted through each of the through hole 71a that are provided for the bolt member 71 of the pair of the attachment bolt 7, the engaging thread 43 of the side stoppers 42 is fixed by welding or the like at a predetermined position, for example, a position away from the through hole 71a of attachment bolt 7 (opposite direction of the flexible pipe main body in the axial direction A) by the predetermined distance D₂, that is, so that a distance between the side stoppers 42 is (distance D₁ between flanges 3+predetermined distance D₂×2). The diameter of the through hole 61a is formed to be smaller than the outer diameter of the side stoppers 42, that is, the outer diameter of the adjustment cap 44 when the adjustment cap 44 is attached to the engaging thread 43. The inner diameter of the housing portion 51b provided for the bolt member 51 is formed to be greater than the outer diameter of the side stoppers 42, that is, the outer diameter of the adjustment cap 44 when the adjustment cap 44 is attached to the engaging thread 43. With this, a configuration is realized with which the side stoppers 42 are housed within the housing portion 51b, and do not fall out of the through hole 51a (see FIG. 14). In the enlarged view of FIG. 14, how the side stoppers 42 of the coupling wire 4 are housed relative to the attachment bolt 7 is shown.

Subsequently, the attachment bolt 7 attached with the coupling wire 4 is threaded with the attachment bolt hole 37 of the pair of flanges 3 to attach to the corresponding flange. With this, the pair of flanges 3 are coupled by the coupling wire 4.

### Effect and Action of Pipe Joint

Next, the effect and action of the pipe joint 1 are described.

FIG. 15 shows a case in which a relative positional displacement between the first pipe 8 and the second pipe 9 coupled via the pipe joint 1 according to this embodiment occurs in a direction B in FIG. 15. As shown in FIG. 15, when the first pipe 8 and the second pipe 9 are displaced from each other in the direction B in FIG. 15, the flexible pipe main body 2 of the pipe joint 1 deforms, accommodating the displacement. Here, the flange 3 slides because the flange 3 is provided slidably with respect to the wire rope 41. For example, the flange 3 slides by the predetermined distance D₂. With this, the first pipe 8 and the second pipe 9 coupled by the pipe joint 1 are not pulled toward the pipe joint 1 and there is no concern of damage to the pipe joint 1, the first pipe 8 and the second pipe 9. Further, the side stoppers 42 provided with the wire rope 41 restrict the maximum amount of displacement in the axial direction A of the flexible pipe main body 2, and accordingly, the flexible pipe main body 2 can be prevented from being damaged.

FIG. 16 shows a relative position between the first pipe 8 and the second pipe 9 coupled via the pipe joint 1 according to this embodiment which is slanted in a direction C in FIG. 16. As shown in FIG. 16, when the first pipe 8 and the second pipe 9 are slanted in the direction C in FIG. 16, the flexible pipe main body 2 of the pipe joint 1 deforms, accommodating the slant. In addition, one of the wire ropes 41 is strained, accommodating the slant. Specifically, one of the wire ropes 41 of the flexible pipe main body 2 resists the deformation. Specifically, in FIG. 16, when the relative position of the first pipe 8 and the second pipe 9 is slanted in the direction C in FIG. 16, while one side of the flexible pipe main body 2 (for example, the upper side) extends accommodating the slant, the coupling wire 4 is strained by being extended by a predetermined amount, thereby restricting further extension. As a result, the maximum amount of displacement of the length of the flexible pipe main body 2 is maintained between the side stoppers 42, in a range in which the flexible pipe main body 2 is not damaged. Thus, the flexible pipe main body 2 is prevented from being damaged.

According to the present invention, the pipe joint 1 is provided with the flexible pipe main body 2 formed in a substantially circular cylinder shape, the pair of flanges 3 provided respectively at the both ends of the flexible pipe main body 2 and coupled to opposing end portions of the first pipe 8 and the second pipe 9, and a plurality of coupling wires 4 that connect the flanges 3. With this, the opposing first pipe 8 and second pipe 9 can be unfailingly coupled via the pipe joint 1. In addition, by using a flexible material for the flexible pipe main body 2, the flexible pipe main body 2 is deformable even when a relative positional displacement or the deformation due to a slant occurs between the first pipe 8 and the second pipe 9, thereby making it possible to accommodate displacements and slants. Further, the flanges 3 are coupled using the coupling wire 4, and the coupling wire 4 can also accommodate displacement and the like, and thus it is possible to prevent the coupling wire 4 from being damaged.

Further, the pipe joint 1 couples the flange pieces 31a, 31b by inserting the coupling bolt 5 provided with the through hole 51a into the coupling hole 33, and couples the pair of flanges 3 by inserting the coupling wire 4 into the through hole 51a of the coupling bolt 5. In this manner, the flange pieces 31a, 31b are coupled using the coupling bolt 5, and the pair of flanges 3 are coupled via the coupling wire 4 using this coupling bolt 5. Specifically, the coupling bolt 5 serves as a member for coupling the flange pieces 31a, 31b, as well as a member for coupling the pair of flanges 3. With this, it is possible to reduce the number of components for the pipe joint 1, thereby reducing the manufacturing cost. Furthermore, in the pipe joint 1, the pair of flanges 3 and the flexible pipe-main body 2 are not integrally formed, and instead, a flange 3 that is dividable and constituted by a plurality of flange pieces 31a, 31b used to engage with the flexible pipe main body 2. Accordingly, it is not necessary to form a complex metal mold, allowing the mass production at low cost.

Further, the distance between the side stoppers 42 provided on both ends of the coupling wire 4 is greater than the distance between the pair of flanges 3. Therefore, even when the first pipe 8 or the second pipe 9 are displaced due an earthquake or subsidence, for example, and the flexible pipe main body 2 of the pipe joint 1 deforms to extend in the axial direction A, it is possible to prevent the pipe joint 1 from being damaged due to a blowout or the like because the coupling wire 4 restricts the maximum amount of displacement of the flexible pipe main body 2. In addition, even when eccentricity of the pipe joint 1 occurs due to, for example, land subsidence or the like, it is possible to prevent the first pipe 8 or the second pipe 9 on the opposite side from being pulled because the flange 3 is provided to be slidable with respect to the coupling wire 4, and the amount of displacement is adjustable. With this, it is possible to prevent the pipe joint 1 and the first pipe 8 or the second pipe 9 from being damaged.

Moreover, the side stoppers 42 are provided with an adjustment mechanism that can adjust the amount of displacement of the pipe joint 1. With this, for example, it is possible to adjust the amount of displacement according to the situation of the installation location, and to use the pipe joint 1 in various locations in the same way. In addition, for example, in a case in which the flexible pipe main body 2 is made of a material subject to deterioration such as rubber, that can be easily damaged, it is possible to prevent the damage due to extension in the axial direction A from occurring by setting the amount of displacement to be small.

The above describes the case in which the coupling wire 4 is inserted into the through hole 51a of the coupling bolt 5 that couples the flanges 3, to couple the flanges 3, however, the present invention works in a similar manner in a case in which the coupling wire 4 is inserted into the through hole 61a of the application bolt 6 to the flanges 3.

According to the present invention, the side stoppers 42 are each provided with an engaging thread 43 and adjustment cap 44 that is threadable with the engaging thread 43. The engaging threads 43 are fixed on both ends of the coupling wire 4. By adjusting the amount of threading between the adjustment cap 44 and the engaging thread 43, it is possible to adjust the amount of displacement of the pipe joint 1.

According to the present invention, the string main body is formed by twisting the plurality of wires. With this, it is possible to improve the strength against with respect to tensile loads and the like occurring in the flexible pipe main body 2. Accordingly, it is possible to maintain the first pipe 8 and the second pipe 9 constant even when the relative positional displacement of the first pipe 8 and the second pipe 9 and the tensile load and the strain that the flexible pipe main body 2 can receive when inflexed occur, allowing the use for an extended period of time.

According to the present invention, the string main body is made of metal. As described above, the metal has ductility and tractility, and it is possible to prevent the string main body from being cut even in a case of a relative positional displacement of the first pipe 8 and the second pipe 9 and a tensile load and strain when flexed.

According to the present invention, the string main body is made of a wire rope. As described above, because the wire rope 41 is used for the string main body, it is possible to prevent a disconnection due to bending fatigue and the like from occurring. With this, it is possible to improve the durability of the string member, allowing use for an extended period of time.

According to the present invention, the flange 3 is provided with a plurality of recesses. With this, it is possible to reduce the weight of the flange 3 by the recesses. Therefore, it is possible to reduce the overall weight of the pipe joint 1.

In the present embodiments, the flange 3 is provided either as the two flange pieces 31a, 31b in a circular arc shape forming a single flange, or as a single flange without being divided into flange pieces in a circular arc shape. However, the present invention is not limited to the above examples, and a single flange may be constituted from more than two flange pieces. Moreover, in the present embodiments, the flange 3 does not have an annular shape. However, the present invention is not limited to the above examples, and the flange 3 can be in a polygonal shape. Further, although the flexible pipe main body 2 is an elastic member such as a rubber layer, the present invention is not limited to this and can be a metal bellows pipe or the like.

While preferred embodiments of the present invention have been described and illustrated above, it is to be understood that they are exemplary of the invention and are not to be considered to be limiting. Additions, omissions, substitutions, and other modifications can be made thereto without departing from the spirit or scope of the present invention. Accordingly, the invention is not to be considered to be limited by the foregoing description and is only limited by the scope of the appended claims.

What is claimed is:

1. pipe joint coupling a first pipe and a second pipe that face each other using an application bolt, the pipe joint comprising:
a flexible pipe main body in a circular cylindrical shape;
a pair of flanges that is provided on both ends of the pipe main body, and are coupled to end portions of the first pipe and the second pipe that face each other; and
a plurality of string members that couple the flanges, wherein
each string member includes a string main body, and a pair of stopping members that are provided on both ends of the string main body with a predetermined distance,
the flanges are formed in an annular shape, and include the flanges are formed in an annular shape, and include a plurality of flange pieces that are separated along lines radially extending from a substantial center, an ear portion provided on an end of each flange piece and having a coupling hole for coupling the flange pieces, a coupling bolt that is inserted through the coupling hole along a length direction of the pipe main body to couple the flange pieces, and an attachment hole through which the application bolt for coupling the first pipe and the second pipe, and
at least one of the coupling bolt and the application bolt is provided with a through hole through which the string main body is inserted in the length direction, and a housing portion for housing the stopping member, the housing portion communicating with the through hole and having an opening area wider than that of the through hole.

2. A pipe joint coupling a first pipe and a second pipe that face each other using an application bolt, the pipe joint comprising:
a flexible pipe main body in a circular cylindrical shape;
a pair of flanges that is provided on both ends the pipe main body, and are coupled to end portions of the first pipe and the second pipe that face each other; and
a plurality of string members that couple the flanges, wherein
each string member includes a string main body, and a pair of stopping members that are provided on both ends of the string main body with a predetermined distance,
the flanges are formed in an annular shape, and include the flanges are formed in an annular shape, and include the application bolt that is inserted through the attachment hole along a length direction of the pipe main body to couple the flange and the end portions of the first pipe and the second pipe, and
the application bolt is provided with a through hole through which the string main body is inserted in the length direction, and a housing portion for housing the stopping member, the housing portion communicating with the through hole and having an opening area wider than that of the through hole.

3. A pipe joint coupling a first pipe and a second pipe that face each other using an application bolt, the pipe joint comprising:
a flexible pipe main body in a circular cylindrical shape;
a pair of flanges that is provided on both ends the pipe main body, and are coupled to end portions of the first pipe and the second pipe that face each other; and
a plurality of string members that couple the flanges, wherein
each string member includes a string main body, and a pair of stopping members that are provided on both ends of the string main body with a predetermined distance,
the flanges are formed in an annular shape, and include a plurality of attachment holes for coupling the flange and the end portions of the first pipe and the second pipe, an attachment bolt hole provided at a middle portion of the attachment holes, and the attachment bolt that is inserted through the attachment bolt hole to attach the string member, and
the application bolt is provided with a through hole through which the string main body is inserted in the length direction, and a housing portion for housing the stopping member, the housing portion communicating with the through hole and having an opening area wider than that of the through hole.

4. The pipe joint according to claim 1, wherein
the stopping member is provided with an adjustment mechanism capable of adjusting the predetermined distance.

5. The pipe joint according to claim 4, wherein
the adjustment mechanism includes a thread member that is fixed to both ends of the string main body, and a cap member threadable with the thread member, and
the predetermined distance is adjusted by adjusting an amount of threading between the thread member and the cap member.

6. The pipe joint according to claim 2, wherein
the stopping member is provided with an adjustment mechanism capable of adjusting the predetermined distance.

7. The pipe joint according to claim 6, wherein
the adjustment mechanism includes a thread member that is fixed to the both ends of the string main body, and a cap member threadable with the thread member, and
the predetermined distance is adjusted by adjusting an amount of threading between the thread member and the cap member.

8. The pipe joint according to claim 3, wherein
the stopping member is provided with an adjustment mechanism capable of adjusting the predetermined distance.

9. The pipe joint according to claim 8, wherein
the adjustment mechanism includes a thread member that is fixed to both ends of the string main body, and a cap member threadable with the thread member, and
the predetermined distance is adjusted by adjusting an amount of threading between the thread member and the cap member.
